(19) United States
(12) Patent Application Publication
(10) Pub. No.: US 2006/0037849 A1
(43) Pub. Date: Feb. 23, 2006

(54) On line off switch

(76) Inventor: Martin E. MacNeilage, Moore, ID (US)

Correspondence Address: Martin E. MacNeilage, P.O. Box 616, Moore, ID, 83255, US

(21) Appl. No.: 11/083,144

(22) Filed: Mar. 18, 2005

Related U.S. Application Data
(63) Continuation-in-part of application No. 10/829,764, filed on Aug. 23, 2004, now abandoned.

(51) Int. Cl. H01H 9/20

(52) U.S. Cl. 200/334

(57) ABSTRACT

This switch in a pencil holder is a simple way to disconnect any on-line activity from your computer. Equal to unplugging the computer from its on-line source, this invention is located on your desk top secondly as a pencil holder. The device requires no battery or A/C power source. With your on-line source as a DSL cable or telephone line, you simply plug the incoming line into the applicable “IN” port located on the back of the pencil holder. From the applicable “OUT” port of the pencil holder, simply plug-in another phone line or DSL cable. That line will lead to the applicable plug-in on the computer. Now the device is hooked up to the on-line source. Again, no power source is needed. On the front of the pencil holder at the bottom, is the side to side toggle switch that on a split second can disconnect you from on-line for any reason. Pop-ups, smut, viruses, and hackers would be reason for using the switch for quick shut down of on-line activity. The even more important use for this switch is when you are not on-line. When the on-line source is not in use, the switch can remain in the “OFF” position, completely securing ones computer from any outside activity. There are no data blockers, no locks, no lights, or anything requiring any power source. This invention completely works on an in-line switch format located at your finger tips by your pens and pencils.

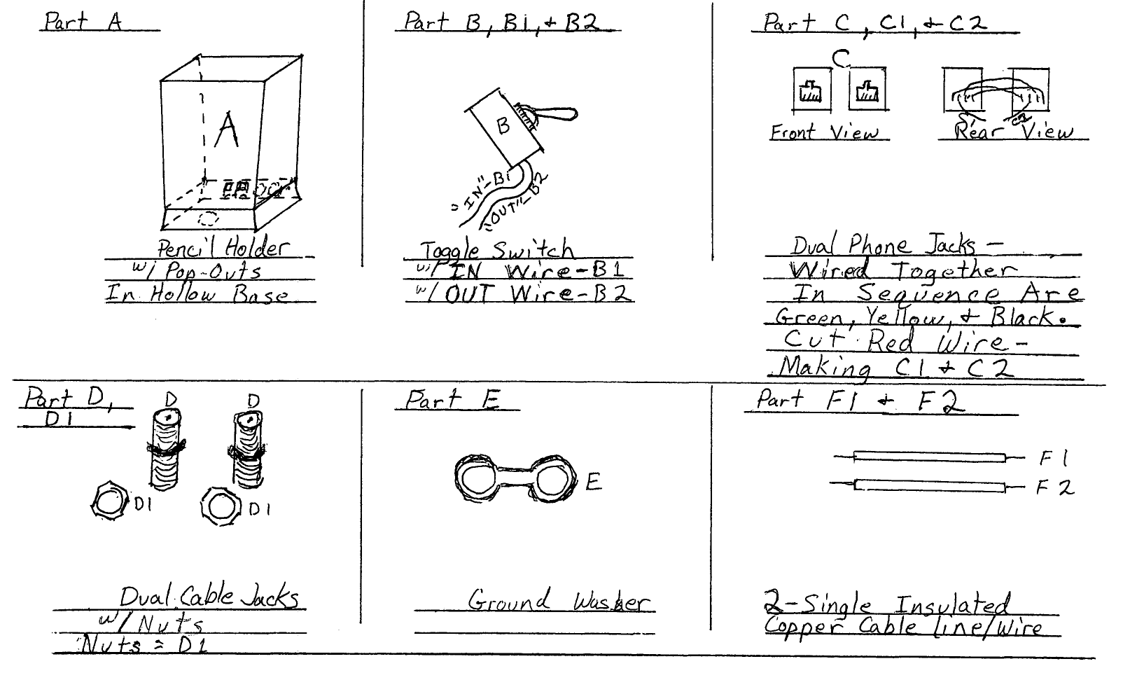

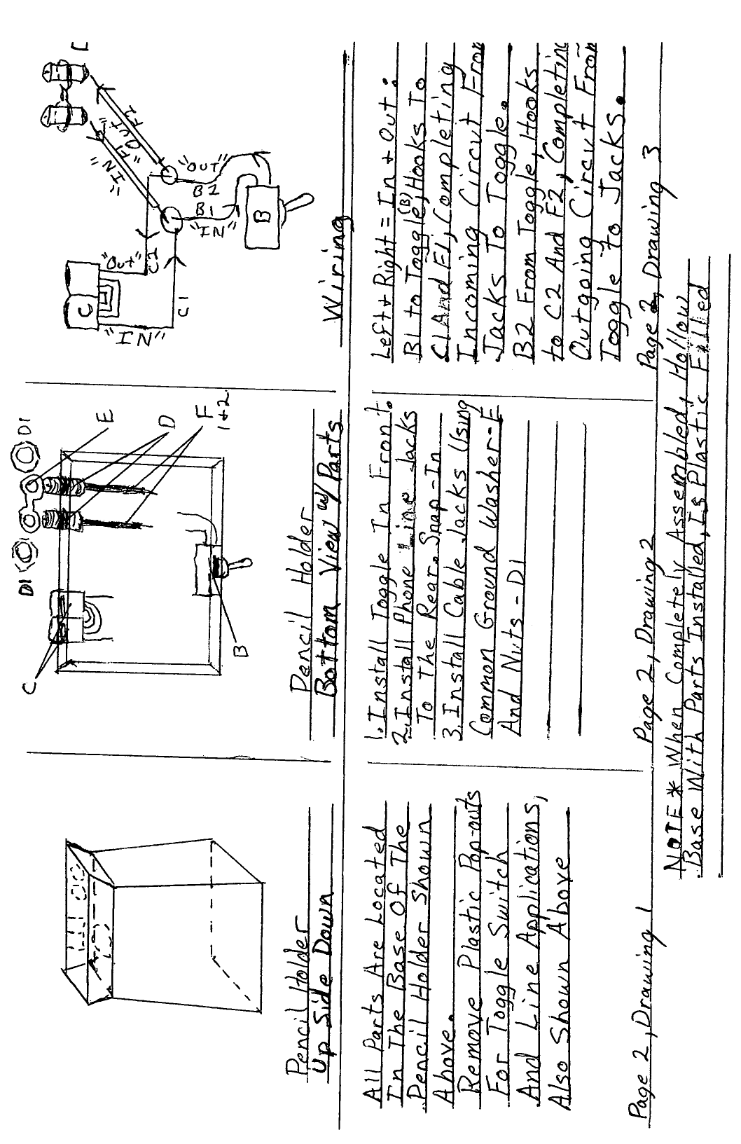

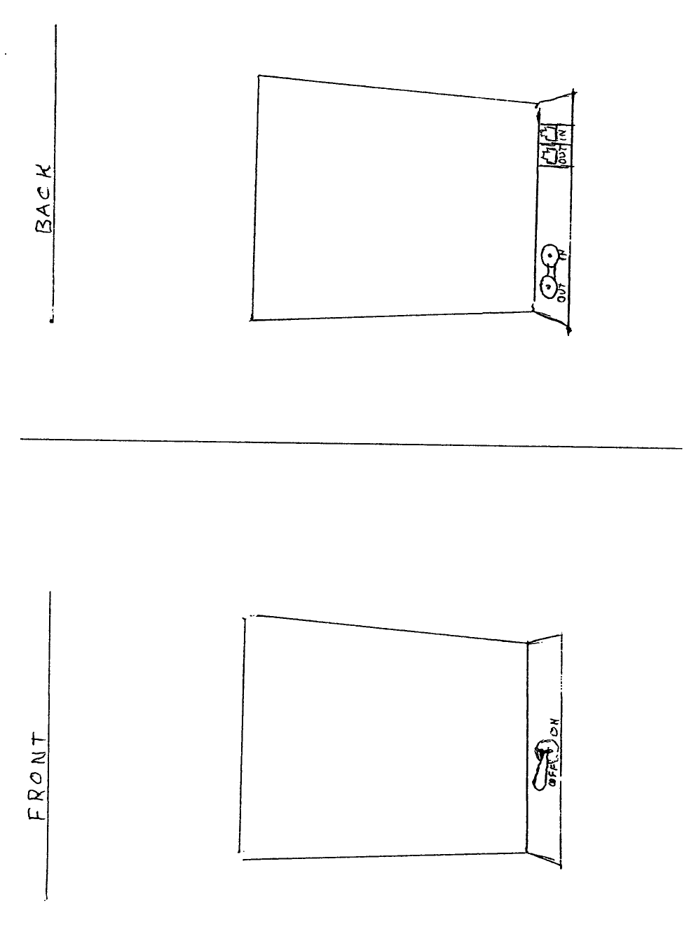

### CROSS-REFERENCE TO RELATED APPLICATIONS

This application, hopefully qualifying as continuation-in-part, is the improved application of an earlier and still active application. The related application is as follows:
application Ser. No. 10/829,764
Filing Date: Aug. 23, 2004
Confirmation Number: 7381
Art Unit: 2832
First Named Inventor: Martin E. MacNeilage

It was felt the prior application was too basic and uninformative to achieve the patent desired. The switched dual phone and dual cable assembly existed in the prior application. It was also felt by adding new matter in a continuation-in-part format, could increase patent possibilities. All of the prior application's information and matter have been carried over to this new application. “New Matter” has been introduced in this application in the form of the structured housing for this invention and for the detail of making and using this invention. When the invention first came to mind, there were several versions of the structure housing of the invention with the same switch to applicable line assembly installed in each one. Some of the housings were, a desk lamp, a basket ball pencil holder, a desk top clock, a piggy bank and more. This felt like too much for one patent application. That was when the prior patent application was presented with the switch to applicable line assembly only, with no structure housing. By installing the simple switch assembly into the first thought of structure housing, being a simple desk top pencil holder, could possibly help more complete the patent application and the potential of this simple and needed invention.

One final difference in the prior and present applications is the title of the invention. Leaning toward the original ideas of when implementing this invention, the title of the first original idea of this invention has been retained as: “ON-LINE OFF SWITCH”, from as in the prior application, “THE SECURITY SWITCH”.

### REFERENCES CITED

| | | | | |
|---|---|---|---|---|
| A | US-5,661,786 | August 1997 | Horn, Douglas | 379/93.02 |
| B | US-5,818,931 | November 1998 | Movassaghi, | 379/445 |
| | | | Abdorreza | |
| C | US-6,660,950 | December 2003 | Fonseca, Danilo E. | 200/51R |
| D | US-6,748,542 | June 2004 | Box, Jeffrey L. | 713/201 |

In the references cited, the material is quite advanced to our simple invention. It is the simplicity of the invention which defines this from the references cited. The references cited contain different data blockers, lock-out devices, and power source needed to operate these devices. The “On-Line Off Switch” is a simple kill switch in an in-line format, installed in a simple desk top pencil holder, to simply protect ones computer and its information from outside invasion of any kind at the flick of an “ON”/“OFF” switch.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

Computers are everywhere and are being used for everything imaginable. When logged on-line, there is so much to see and a little we probably do not. That is where the first part of the use comes from with this invention. There are many annoying things that happen in a seconds notice when on-line. Ad pop-ups can get out of control. Smut can flood your computer quickly. Computer hackers can enter your computer while you are right there working. Also, virus problems are everywhere on-line. During an attack from one of these annoyances, you can reach to your physical desk top and flip a switch which disconnects the incoming on-line source immediately.

Secondly, when you are not on-line working at your computer or your computer is setting idle but you are still hooked up to the line that supports the on-line activity, you can still be invaded by hackers and viruses. With this invention, everytime you sign-off from on-line, the invention should be switched to “OFF” (for off-line) to stop any attempted invasion toward the computer from outside sources.

Senior Citizens and the country folk out there like things simple to use and understand. They also love their life to be as secure as possible. The computer industry is a big scary thing to alot of the said people above. This invention would help give that extra piece of mind in helping people feel more secure with their computer and the world they face out there.

### FIELD OF THE INVENTION

This invention relates to a simple device that allows the computer owner/operater to be more secure with their computer and its contents through the flick of a switch on their physical desk top.

### DESCRIPTION OF RELATED ART

Not Applicable

### BRIEF SUMMARY OF THE INVENTION

This invention's uses are important and simple to use on an everyday basis, on every computer hooked to an on-line source through telephone line or DSL cable. Located at your finger tips in a simple but nice pencil holder, the “IN” and “OUT” lines headed away from you from the back of that pencil holder, “IN” representing incoming from wall and “OUT” for outgoing to computer, and the side to side toggle switch at the front and bottom of that pencil holder, makes the computer users security increase. The manual switch in the “OFF” position, simply stops any entry from on-line activity with no power source needed for the switch. The same switch in the “ON” position, allows total access to on-line activity but allows instant turn off of on-line activity if desired, again, with no power source needed.

All of this to be simply implemented from your finger tips, on your physical desk top, with your pencil holder.

The pencil holder's hollow bottom houses the “IN” and “OUT” ports for phone line or DSL cable out the back direction of the pencil holder. The switch on the front is also located in the hollow bottom. Once the main polarity wire of the phone line (Red) and the main polarity of the DSL cable (Copper) are broke at the switch, we have a computer on-line kill switch with no power necessary, in the shape of a desktop pencil holder.

### BRIEF DESCRIPTION OF THE SEVERAL VIEWS OF THE DRAWINGS

Page 1 of drawings is for parts needed for this invention. Page 1 has six different parts drawings.

Page 1; Part A: is the invention's structure. Its use and shape is ideal for desktop pencil holder. In the hollowed base from underneath, depth ¾ inch, are molded pop-outs where the “On-line Off Switch's” functional parts are to be installed.

Page 1; Part B, B1, and B2: is the inventions switch “B” with two fixed lines, B1 for “IN” and B2 for “OUT”.

Page 1; Part C, C1 and C2: are dual phone application jacks “C” wired in sequence to each other. Four wires in total; green, yellow, and black are connected solid to each side of the phone jack. The fourth wire is red, and severed, leaving a single red wire sticking out from each half of the dual phone jack. This creates C1 for incoming switched wire and C2 for the outgoing switched wire for the dual phone jack.

Page 1; Part D, and D1: are the cable application jacks “D”. D1 are the fasteners for D.

Page 1; Part E: is the side by side ground washer that connects the ground circuit between “D”, the cable connections.

Page 1; Part F1, and F2: are the “IN” and “OUT” switched wires for the cable application.

Page 2 of drawings is for the assembly of this invention in three different drawings with brief narrative text following below each drawing.

Page 2, Drawing 1: is the structure “A” turned up side down for installing the function parts. Easy removal of the pop-outs shown, can be achieved with a slight tap to the areas. One pop-out circle on front for the switch “B”. A square pop-out on the back for phone jack “C” application, and a double circle pop-out on back for cable “D” application.

Page 2, Drawing 2: is the installation of the applicable line jacks “C and D” and the switch “B”. From the inside of the hollowed bottom, install the switch “B”, handle first through base wall using the nut to tighten it in. On back base wall the phone line jack “C” snaps into place. Also, on the back base wall the cable application “D” is fastened in the same since as the switch “B” with nuts D1 to tighten in, not forgetting to install the ground washer “E” which connect the ground circuit between the “IN” and “Out” of the cable application. Drawing 2 shows the components installed from the underneath side of the structure “A”.

Page 2, Drawing 3: is the wiring format for the line applications “C” and “D” to the toggle switch for the “ON” and “OFF” activity. With the “IN” from both line applications “C” and “D” connected to the “IN” of the switch “B” and with the line “OUT” of both line applications “C” and “D” connected to the line out of the switch “B” the invention is wired to be used.

*Note: after the components' installation and wiring format are achieved, the hollowed base with its new installations and wiring are encased in a plastic filler that protects the functioning parts of the “On-Line Off Switch” for the natural life of the parts.

Page 3: is the final view of the “On-Line Off Switch” pencil holder when completely assembled and ready for market.

Page 3, Front View: shows the pencil holder structure “A, right side up, with the switch “B” sticking out the bottom, front.

Page 3, Back View: shows the pencil holder structure “A”, right side up, with both phone line “C” and cable “D” applications accessible at the bottom.

### DETAILED DESCRIPTION OF THE INVENTION

This invention is for securing ones computer the entire time one is not on-line, from any on-line activity at all through the flick of a switch. This invention can also be used during ones on-line activity. When the unfortunate occurrence like mass pop-ups, smut, virus', or hackers appear, it can be dealt with at the flick of a switch.

On the desktop, next to every computer, can be a simple square pencil holder that has a simple switch on the front at the bottom. Turned around to the back side are the plug-ins applicable for phone line and DSL cable. Wired like a kill switch through the main polarity wire of a phone line, red, and the main polarity wire in cable, solid copper, the switch breaks the connection in the “OFF”, for off-line, position with no AC or DC current needed, thus protecting ones computer completely from on-line activity the entire time it is off.

Turned to the “ON” position, this invention allows total access to on-line activity by the said main polarity lines being activated through the switch, but allows immediate disconnect from on-line activity if so desired.

Every bit of security we can achieve in this life is a great asset to our lives. Especially in the vastly exploding computer industry. An invention structure of a pencil holder, to add such security in as simple as an “ON”/“OFF” switch to block out any incoming on-line activity through applicable line will be an asset to take to the public and business worlds out there.

What is claimed is:

1. A simple in-line switch located at the front and bottom of a square pencil holder applicable to phone line and cable connections, located on the back and bottom of the pencil holder, will in the “OFF” position (for off-line), completely secure a computer from outside or on-line activity with no power source needed.

2. A simple in-line switch in claim 1 in the “On” position (for on-line), allows complete access to on-line activity, with no power source needed.

3. A simple in-line switch in claim 2 can be used as instant shutoff from hackers, viruses, smut, and pop-ups.
